(19) United States
(12) Patent Application Publication
(10) Pub. No.: US 2011/0112222 A1
(43) Pub. Date: May 12, 2011

(54) FIBER REINFORCED POLYMERS, EPOXY-BASED POLYMERIC COMPOSITIONS AND USE THEREOF

(76) Inventors: Giuseppina Barra, Salerno (IT); Marino Lavorgna, Puglianello (BN) (IT); Giuseppe Mensitieri, Napoli (IT); Filomena Piscitelli, Maddaloni (CE) (IT)

(21) Appl. No.: 12/943,270

(22) Filed: Nov. 10, 2010

(30) Foreign Application Priority Data
Nov. 12, 2009 (IT) MI2009A001980

(51) Int. Cl. C08L 63/00; C08K 3/40; C08K 3/36; C08K 3/04; B82Y 30/00

(52) U.S. Cl. 523/466; 525/523; 523/400; 525/396; 525/122; 523/468; 977/773

(57) ABSTRACT

A composition including an epoxy resin having at least a difunctional epoxy resin and at least one cross-linking agent for epoxy resin. The difunctional epoxy resin has a viscosity of from 1000 to 5000 mPa·s. The composition may include a low viscosity diluent for modulating the composition viscosity in an amount not higher than 10% by weight.

### CROSS-REFERENCE TO RELATED APPLICATIONS

The present application claims priority under 35 U.S.C. §119 to Italian Patent Application No. MI2009A01980 (filed on Nov. 12, 2009), which is hereby incorporated by reference in its entirety.

### FIELD OF THE INVENTION

The present invention refers to fiber reinforced materials with polymer matrix, known also as FRP materials (fiber reinforced polymers) or fiber reinforced polymers, particularly of the epoxy-based polymer matrix type, the matrix being cross-linked at low temperature. Particularly, but not limitatively, the present invention relates to FRP materials for use in civil applications, such as, for example, structural reinforcement, restoration and/or structural repairing of damaged buildings.

### BACKGROUND OF THE INVENTION

FRP materials based on epoxy resins are known. Epoxy resins are often employed in civil buildings, mines or for site restoration and they are the polymer matrix of the so called FRP.

For such applications the epoxy matrixes are usually cross-linked at low temperature (e.g., environmental temperature). Commercially available for applications in FRP at environmental temperature, epoxy systems are specifically formulated to reach in a very short time at environmental temperature (25-30° C.) the most elevated conversion rate.

As known, cross-linking is defined as the process controlled in time by the temperature at which an epoxy/cross-linking mixture is transformed in a solid material. A complete cross-linking, defined as the condition in which all epoxy groups have been reacted, is generally unattainable. To approach a complete cross-linking the polymer matrix has necessarily to be cross-linked at a temperature higher than its glass transition temperature. The glass transition temperature of a completely cured system is generally named “end glass transition temperature.”

The relationship between end glass transition temperature T_{gu} and the material real temperature T_{g} (T_{gu}/T_{g}) is a convenient and useful way to estimate the cross-linking rate of an epoxy resin-cross-linking system. It is a common belief that systems characterized by a cross-linking rate not near to the unit show poor mechanical properties and poor dimensional stability. In fact, on regard that said systems are weak, brittle and not utilizable for main applications. The search for new formulations is hence directed essentially to materials characterized by high cross-linking rate.

Cross-linking rate can be optimized, meaning, its value must be near to the unit, if T_{gu}/T_{g} value is near as possible to the unit. Practically, materials are formulated in such a way that the end glass transition temperature is near to the application temperature. In particular, for applications in which resins cannot be cross-linked at high temperature, cross-linking rate is maximized, thus causing reduction of end glass transition temperature on values near the temperature of end application, utilizing the plasticizing effect of reactive solvents.

For reaching a conversion unitary value employing cross-linking process at low temperature, according to widespread technique it is common to add a high percentage of a reactive solvent to the formulation. Reactive solvents or catalysts, such as polyols, once added to the formulation, are able to reduce T_{gu} so as to make it comparable to the effective T_{g}, and hence, to modulate the conversion rate. They affect both T_{g} and T_{gu}. Reactive solvents take part in cross-linking reaction, consequently the cross-linked material properties, such as glass transition temperature T_{g}, are influenced by their molecular structure; moreover, they share in an increase of crosslinked resin flexibility and then in a reduction of end glass transition temperature T_{gu}.

Related art documents are cited relating to materials containing epoxy resins crosslinked at quite low temperatures.

WO-A-1989/004335 discloses compositions including a mixture of: (A) an epoxy resin composition consisting essentially of: (1) at least an epoxy resin having on average not more than 2 epoxy groups per molecule, (2) at least an epoxy resin having on average more than 2 epoxy group per molecule, and (3) at least a gummy or elastomer, and (B) eventually a low viscosity reactive solvent.

U.S. Pat. No. 4,221,890 discloses an epoxy resin composition useful for repairing concrete surfaces. The composition includes an epoxy resin cross-linked with polyamines and phenol accelerators. Epoxy resin is conditioned with a modifier including glycidilethers, phenol accelerators and phosphites before being combined with a cross-linker.

U.S. Pat. No. 3,989,673 describes an epoxy resins and cross-linkers system that can be cross-linked at low temperatures.

U.S. Pat. No. 6,987,161 describes cross-linking agents for epoxy resins that should be used at temperatures lower than cross-linkers actually available.

U.S. Pat. No. 4,772,645 discloses one component heat-stable epoxy resins compositions, including an epoxy resin, an amount of cyclic-aliphatic or not aromatic polyol with 2 to 18 carbon atoms, whereby at least two hydroxy groups of the polyol are primary or secondary groups and the polyol is devoid of strong acid groups and devoid of electron drawing substituents.

U.S. Pat. No. 5,216,093 discloses an epoxy resin composition cross-linkable at low temperature including a main agent based on epoxy resin to which a carboxylic acid ester of a polyhydroxy alcohol is added and that contains an epoxy resin having urethan bonds in its molecules, and a cross-linker consisting of an alicyclic amine compound.

### SUMMARY OF THE INVENTION

Applicant has found that the presence of a reactive solvent allows the applied material to be characterized by an end glass transition temperature that is only 30-35° C. higher than the temperature at which it was applied (e.g., environmental temperature). It has been noted that when such materials are exposed to high temperature conditions, they collapse to a gummy state giving rise to a loss of mechanical properties.

Applicant has also observed that due to the high exposition temperature in warm weather climates, such as some Mediterranean areas, FRP effective temperature exceeds end glass transition temperature T_{gu} of their polymer matrix, so that it loses the mechanical properties and effectiveness thereof.

Applicant has realized that referring to the epoxy matrices used for realizing FRP and actually on the market, the existing gap between environmental temperature and temperature at which FRP material is exposed is a factor limiting their use. In particular, it has been noted that materials on the market based on fiber reinforced polymers, FRP, realized for reaching maximal cross-linking rate at environmental temperature and intended for a civil use, lose their mechanical properties at a temperature of a few grades higher than their operative temperature.

In particular, there has been problems in the art finding formulations based on epoxy resins with satisfactory mechanical and physic properties so as to permit the installation of corresponding FRP at environmental temperature, thus obtaining a product that can be sure also in a warm weather climate, such as, for example, some Mediterranean areas.

Applicant has found that employing in FRP materials an epoxy base matrix having a little amount of the material not cross-linked during the installation phase, not only mechanical performances of FRP material are not negatively influenced, but advantageous results are attained as far as mechanical properties are concerned.

Accordingly, embodiments are related to a composition that can include at least one of the following an epoxy resin that has at least a difunctional epoxy resin having a viscosity at environmental temperature in a range of between 1000 to 5000 mPa·s; and at least one cross-linking agent for epoxy resin, said epoxy resin having a cross-linking temperature at a predetermined temperature.

Embodiments are related to a reinforced polymer that can include at least one of the following: a polymer matrix including an epoxy resin that has at least a difunctional epoxy resin having a viscosity at environmental temperature in a range of between 1000 to 5000 mPa·s, and at least one cross-linking agent for epoxy resin, said epoxy resin having a cross-linking temperature at a predetermined temperature; and reinforcing fibers incorporated into said polymer matrix.

Embodiments are related to a method of using a fiber reinforced polymer material that can include at least one of the following: providing the reinforced polymer material by combining at environmental temperature reinforcing fibers with a polymer matrix that includes an epoxy resin that has at least a difunctional epoxy resin having a viscosity at environmental temperature in a range of between 1000 to 5000 mPa·s, and at least one cross-linking agent for epoxy resin, said epoxy resin having a cross-linking temperature at a predetermined temperature; and then applying the reinforced polymer material to a structure which is exposed to a temperature greater than 40° C.

### BRIEF DESCRIPTION OF THE DRAWINGS

Further characteristics and advantages of embodiments of the invention will be evident from the following description of embodiments and variants thereof given as exemplificative. Referring to the alleged drawings:

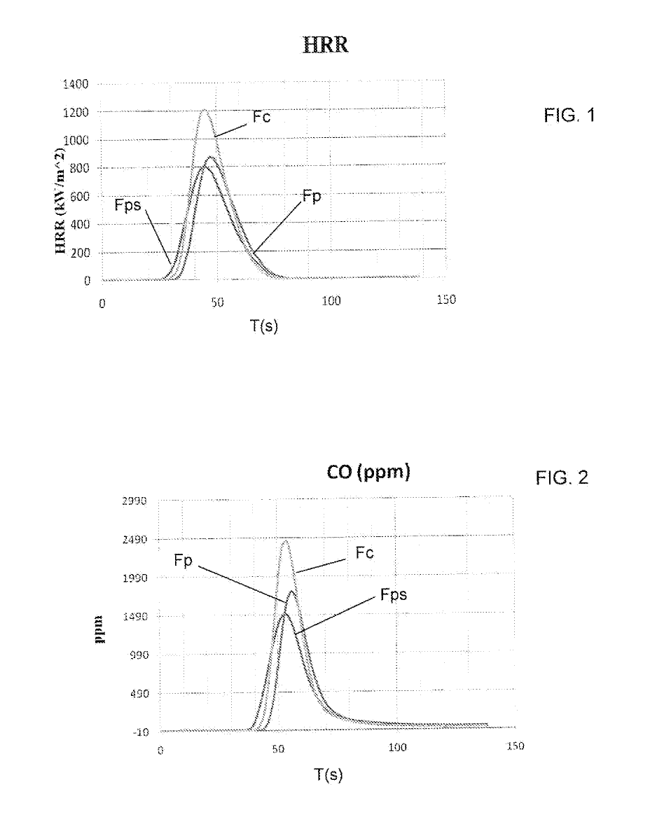

Example FIG. 1 illustrates curves obtained with tests carried out with a cone calorimeter of the heat release rate of a sample realized in accordance with a known technique and samples realized in accordance with embodiments.

Example FIG. 2 illustrates curves obtained with tests carried out with a cone calorimeter of CO release of a sample realized in accordance with a known technique and samples realized in accordance with embodiments.

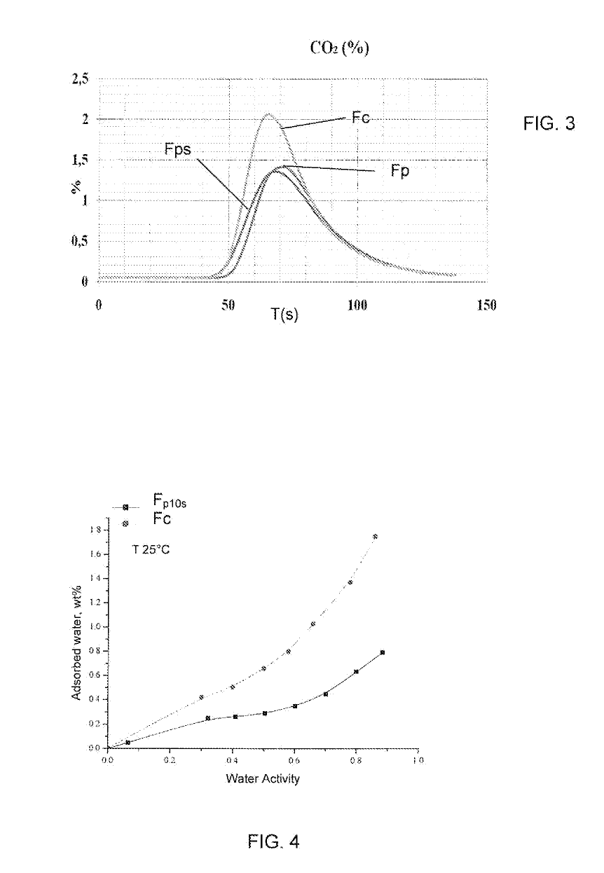

Example FIG. 3 illustrates curves obtained with tests carried out with a cone calorimeter of CO₂ release of a sample realized in accordance with a known technique and samples realized in accordance with embodiments.

Example FIG. 4. shows curves of water adsorption of a commercial sample and of a sample realized in accordance with embodiments.

### DETAILED DESCRIPTION OF THE INVENTION

Hereinbelow definitions are provided, useful for the comprehension of the above description.

Composite or composition=material including two or more distinct parts operating together. Often one of the parts is harder and stronger and constitutes reinforcement, whereas the other part(s) is a material transferring strains and is usually indicated as matrix.

Multifunctional epoxy resin=epoxy resin presenting more than two epoxy groups.

Glass transition temperature=temperature at which transition in amorphous domains between glass and gummy state does occur.

Practice temperature=temperature at which the material was exposed during is normal life cycle.

Epoxy resins-novolac=resins obtained by reacting epichlorohydrin with condensation products of phenol and formaldeyde. Epoxy resins from novolac are linear phenol thermoplastic, partially cross-linked resins.

In accordance with embodiments of the invention, a fiber reinforced material is provided with a polymer matrix, or shortly FRP (fiber reinforced polymer) or “fiber reinforced polymer” having a composite material including a polymer matrix and reinforcing fibers. For example, as reinforcing fibers, carbon fibers can be employed (particularly suitable for civil engineering applications), thus obtaining CFRP polymer. Alternatively, instead of carbon fibers, glass fiber or Kevlar® can be employed that exhibit high resistance. Hereafter, for brevity the fiber reinforced polymer will be named FRP polymer.

Referring to a civil engineering application of embodiments, the fiber reinforced polymer can have a shape of a thin rolled section that can be connected to structural elements. Fiber reinforced polymer FRP increases significantly the ability to bring load of the elements. Polymer matrix has the role to protect fibers and maintain their alignment, thus allowing an uniform distribution of loads among the fibers as such. Polymer matrix is an epoxy-based matrix and has a composition that includes an epoxy resin that has in its turn at least a di-functional epoxy resin and at least a cross-linker (or hardener).

In accordance with the illustrative application type shown above, the polymer matrix on epoxy base has a low cross-linking temperature. In particular, the polymer matrix on epoxy base has a cross-linking temperature of from 5° C. to 60° C., preferably of from 10° C. to 50° C. and more preferably from 15° C. to 35° C.

Moreover, referring again to the illustrative application shown above of FRP polymers, the polymer matrix being part of the fiber reinforced polymer is not completely cross-linked at the installation temperature of FRP polymer. For example, the cross-linking rate α% of polymer matrix on epoxy base is of from 80% and 90%, preferably of from 84% and 93%, more preferably of from 87% and 92%. The di-functional epoxy resin of polymer matrix shows a viscosity of between 1000 and 15000 mPa·s, preferably of between 3000-12000 mPa·s, more preferably of between 5000-9000 mPa·s. Such viscosity values allow the polymer matrix to enter as desired into the reinforcing fibers employed for the FRP polymer achievement. The viscosity can be measured with the aid of a Brookfield viscosimeter.

Advantageously, it is possible not to add any diluent or solvent in the polymer matrix. Notwithstanding, it is optionally possible to use a reactive solvent of low viscosity for modulating viscosity of the polymer matrix used for impregnating the fibers. For example, a possible diluent includes a mono- or diglycidilether as a reactive solvent, exemplary having an equivalent weight (EEW) between 100 and 170 g/eq and eventually a non-reactive solvent with low evaporation temperature, preferably methanol or ethanol. If desired, the solvent has a percentage by weight, referred to the entire polymer matrix composition, not higher than 10%. Consequently, both polymer matrix and FRP polymer can contain or not, only in a limited amount, additives having the same action of solvents. As to the di-functional epoxy resin, preferably it is bisphenol-A diglycidilether, DGEBA and/or bisphenol-F diglycidilether, DGEBF.

In accordance with embodiments, epoxy resin can also include at least a multifunctional epoxy resin. For example, the multifunctional epoxy resin is selected from the group consisting of tetraglycidil-4,4′-diaminodiphenylmethane (TGDDM), triglycidil-p-aminophenol (TGAP) and epoxy-novolac resin. As to cross-linking agent, it can be an aromatic or aliphatic amine. Preferably meta-xylylendiamine having an equivalent weight (EEW) of 35 g/mole eq is used.

It should be noted that polymer matrices and relative fiber reinforced polymers described above are characterized by a glass transition temperature the value thereof being about 20-40° C. higher than the temperature at which they are applied (environmental temperature 15-30° C.). For these polymer matrices and relative fiber reinforced polymers, the end glass transition temperature is in a range of between 85 to 90° C. (T_{gu}). Consequently, when such materials are submitted to an increase of their operative temperature, they will further cross-link (i.e., undergo a further cross-linking process), so that as a result there will be an increase of the epoxy groups conversion with subsequent increase of their T_{g}. In particular, the glass transition temperature will increase, thus approaching the end glass transition temperature value.

It has been realized that the material resulting from such a conversion increase will maintain its mechanical and structural properties also at a temperature much higher than the mean environmental temperature of a warm weather environment such as certain Mediterranean areas. At a temperature range until exposition temperature (that for civil applications can reach also value in a range of between 85 to 90° C.), these materials maintain their mechanical and structural properties. For example, the mechanical and structural properties of fiber reinforced polymer are maintained also at a temperature of the environment in which it is applied higher than 40° C. Such temperature conditions are verified for example for civil applications on infrastructures/construction in warm weather environment such as certain Mediterranean areas.

Applicant has experimentally realized that for these materials type described above, a little amount of not cross-linked material not only does not influence negatively the mechanical performances, but can also be advantageous and desirable. On the contrary, FRP polymers of the prior art and available on the market, designed for obtaining the maximal cross-linking rate at environmental temperature, lose their mechanical properties at temperature only few grades higher than that of their application.

In accordance with embodiments of the invention, as to the epoxy resin, it can include, for example, at least a first diglycidilether compound having no more than 2 epoxy groups per molecule, and, for example, characterized by an equivalent weight in a range of between 150 to 250 g/eq, and eventually a second polyglycidilether compound having more than 2 epoxy groups per molecule, characterized, for example, by an equivalent weight (EEW) in a range of between 150 to 300 g/eq.

As to the cross-linking agent, it can preferably include an accelerator, for example, as an accelerator selected from the group consisting of aliphatic or aromatic alcohol, aliphatic polyalcohol and preferably nonylphenol or hydrocarbon resin. The polymer matrix can also include a filler that, for example, can be selected from the group including systems based on silica nanoparticles dispersed in epoxy resins or systems, such that nanoparticles are directly produced in situ with sol-gel method.

Referring to the systems based on nanoparticles, the filler can be a silica nanoparticle dispersion in, for example, a diglycidilether compound of epoxy resin having no more than 2 epoxy groups per molecule, whereby the silica content is 40% by weight, the EEW (equivalent weight) is 300 g/mol eq. Typically, the silica nanoparticles have diameters with a mean value of 20 nm.

As to the systems in which the silica nanoparticles are directly produced in situ with sol-gel method, the filler can be a system in which the silica particles are produced during mixing a dispersion of organo-silica precursors in epoxy resin and cross-linking agent. In particular, organo-silica precursors are organosilanes selected from the group consisting of tetraethoxysilane, glycidiloxypropyltrimethoxysilane and aminopropyltriethoxysilane.

Examples of stoichiometric relationship: Exemplificative stoichiometric relations are presented, with reference to the mixture containing the above described components, that is: epoxy resin (component A), filler (component B), diluent (component C), cross-linking agent (component D) and accelerator for crosslinker (component E). Epoxy resin is in the range of between 60 to 90% by weight, and it includes a mixture of difunctional epoxy resin (DGEBA and/or DGEBF) and polyfunctional epoxy resin. The amount of said polyfunctional epoxy resin in component A is of a range of between 0 to 15%. Filler is in range between 0 to 40% of the entire mixture, both when systems based on nanoparticles are used and when systems in which silica nanoparticles are directly produced in situ with sol-gel method are used.

The inorganic amount as SiO₂ content is in a range of between 0 to 20% by weight. As mentioned above, the low viscosity diluent, when provided, is added in an amount in a range of between 0 to 7%, preferably less than 5%. The cross-linking agent is present in an amount as defined by the relationship [amine groups equivalents]/[epoxy groups equivalents] in a range of between 0.95/1 to 1/1. Accelerator is employed in an amount in a range of between 0 and 5% by weight.

Example 1: polymer matrix and fiber reinforced polymer. According to example 1, polymer matrix was realized with the following formulation Fp. Fp formulation includes component 1 and component 2 in a mixture relation 85:15. Component 1 is a homogenous and degased mixture having the following composition:

| Components | % (p/p) |
|---|---|
| A: DGEBA | 77 |
| A: DGEBF | 19 |
| E: accelerator (particularly nonylphenol) | 4 |

Component 2 is the cross-linking agent constituted by meta-xylylendiamine (MXDA). The mixture of component 1 and component 2 thus obtained has a viscosity (Brookfield method) of 5000 mPa·s.

Preparation of fiber reinforced polymer FRP is described as follows. Carbon Fiber reinforced polymer (FRP) includes the polymer matrix obtained with Fp formulation. For preparing the fiber reinforced polymer, component 1 and component 2 are mixed at environmental temperature in a weight ratio 85:15, avoiding air bubbles formation. The mixture is then applied for 1 hour at environmental temperature on an uni-axial 600 mesh carbon fiber fabric and is allowed to crosslink for 12 hours at environmental temperature.

Comparative analysis between FRP polymer in accordance with example 1 and a FRP polymer of the prior art is described as follows. Mechanical properties of reinforced polymer specimens FRP obtained impregnating a carbon fiber fabric with a commercial matrix formulation and with a matrix obtained with formulation described in example 1 have been compared. Afterwards commercial formulation is designed as Fc. The properties have been evaluated at environmental temperature and after exposition at 65% relative humidity (RH) at 70° C. Tensile stress tests have been carried out according to ASTM D3039/3039M rule, and E modulus (Gpa), tensile stress εᵤ (adim.) and breaking stress σᵤ (Gpa) mean values obtained with 20 repetition are reported in the following table 1.

TABLE 1

| | | | | T = 70° C. | | | | | |
|---|---|---|---|---|---|---|---|---|---|
| matrix | T = 25° C. | | | RH = 65% | | | | | |
| formula- | E | | | E | | | difference % | | |
| tion | (Gpa) | εᵤ | σᵤ | (Gpa) | εᵤ | σᵤ | ΔE | Δεᵤ | Δσᵤ |
| Fc | 221 | 1.27 | 2806 | 222 | 0.94 | 2056 | 0 | −26 | −27 |
| Fp | 215 | 1.39 | 2971 | 236 | 1.37 | 3211 | 10 | −1 | 8 |

It should be observed that for FRP materials, E modulus appears to depend strongly on fiber type utilized for reinforcement and on reinforcement/matrix ratio. On the contrary, ultimate strain εᵤ and breaking stress σᵤ are correlated to the polymer matrix capability to give out loads on the fibers. In particular, at 70° C. the latter properties drastically worsen for samples obtained from the commercial matrix (Fc). On the contrary, samples obtained from example 1 formulation (Fp) maintain their properties and thus they are particularly suited for duty temperatures up to 70° C.

Further formulation examples: pure formulation and nanocomposite formulation are described as follows. Following table 2 shows the ratio among the different components for two different formulations according to two particular embodiments: a pure formulation Fp (without filler) and a nanocomposite formulation Fps (containing silica nanofillers).

As shown in Table 2, Pure formulation Fp includes component A=DGEBA+DGEBF, component E=nonylphenol and component D=meta-xylylendiamine (MXDA).

TABLE 2

| | components/formulation | | | | |
|---|---|---|---|---|---|
| | | | filler B (% by | crosslinker D | |
| | epoxy resin: A | | weight) | (% by weight) | accel. E (% |
| | (% by weight) | | silica/epoxy | meta- | by weight) |
| | DGEBA | DGEBF | (40/60%) | xylylendiamine | nonylphenol |
| pure = Fp | 65.06 | 16.24 | 0 | 15.3 | 3.4 |
| nanocomposite = Fps | 57.95 | 15.75 | 8.3 | 14.7 | 3.3 |

Components A and E are mixed together at environmental temperature avoiding air bubbles, then component D is added. Resulting reactive mixture is quickly stirred and applied within 1 hour from its preparation at environmental temperature to give three different sample types as described afterwards.

As shown in Table 2, for nanocomposite formulation Fps, components A, B and E are mixed together at environmental temperature avoiding air bubbles and silica crystals. Then component D is added. Resulting reactive mixture, having at 0 time a viscosity of 6000 Mpa·s (Brookfield), is quickly stirred and applied within 1 hour from its preparation at environmental temperature to give three different sample types as described afterwards.

From both the formulations described above, three sample types are obtained: thin film, sample of “dog bone” type and FRP test pieces. Thin film (thickness=0.5 mm) was prepared spreading the mixture on a PET sheet with the aid of an Elcometer Docor Blade set on a 0.8 mm thickness. The “dog bone” type samples were obtained pouring the reactive epoxy mixture in a teflon mould having the dog bone shape. Fiber reinforced polymer samples (FRP) are prepared pouring the reactive mixture on a commercial fabric of unidirectional continue carbon fibers. A 1000 g amount epoxy mixture per m² fabric used as reinforcement is employed. All samples are allowed to end their own cross-linking process at environmental temperature 25±2° C. in 7 days before being employed. Performance of these materials has been valuated using the following different techniques: dynamic mechanical analysis (DMA), differential scanning calorimetry (DSC), thermomechanical analysis (TMA) and water adsorption isotherms determination.

Effect of environmental agents on materials properties change has been also studied. This analysis is necessary for operative structures computation in a long time and for temperature and humidity different conditions. Effect of simulated aging, named accelerated climatic test (ACT), has been evaluated on samples exposed 7 months at cycles in which temperature varies from −5 to 40° C. and relative humidity from a range of between 0 to 80%. Dynamic-mechanical materials properties have been monitored during a 7 months hygrothermic cycle.

Dynamic-mechanical properties have been determined employing a thermal mechanical analyzer TA Instrument Q 800. Dynamic-mechanical spectra have been registered in tensile procedure at 1 Hz frequency and 5 μm amplitude and at heating rate of 3±° C./min in a range of between −50 to 250° C. Experiments have been carried out on 7 months cross-linked samples, on up to 7 months aged samples.

Differential scanning calorimetry (DSC) analysis have been carried out employing a TA instrument Q 1000. Instrument has been gauged for temperature and enthalpy with indium (Tm=156.6° C. and H=28.45 J.g-1) and cyclohexane (Tm=6, 7° C.). Tests have been carried out in a nitrogen inert atmosphere. Samples, about 5 mg each, are sealed hermetically in aluminium capsules and submitted to 2 consecutive scannings at 10° C./min a range of between −40° C. to 250° C. for eliminating eventual relaxation and improve the glass transition temperature determination. Residual heat for cross-linking is assumed as the enthalpy produced by exotherm area observable during the first scanning Glass transition temperature is assumed as flex temperature in the glass transition range. The instrument TA analysis software has been used.

Burning experiments have been carried out in a oxygen consumption calorimeter (cone calorimeter) at a 50 kW/m² incident heat flux. The heat release rate, CO and CO₂ yield, have been measured and reported as mean curves of three repeated experiments.

Thermomechanical analysis (TMA) was conducted to determine thermal expansion coefficient. Length change, as ratio between length variation and initial length (DL/Lo), has been measured with the temperature change increasing with a rate of 3° C./min from a range of between 50 to 155° C.

Mechanical strain test was conducted to determine mechanical properties at strain according to ASTM D638-03 rule. The samples having a dog bone shape were tested with the aid of Instrom 4505 (UK) using a 1 KN load cell. Tests have been carried out at environmental temperature at 1 mm/min tensile rate, applying a preload of 20N. Properties including end resistance, stress and breaking strain and E modulus in linear region have been determined.

Water adsorption isotherms, particularly, steam adsorption isotherms have been determined at 25° C. and 45° C. with the use of a Q5000 SA analyzer from TA Instruments. The water amount adsorbed was determined as weight increase of a sample maintained at constant temperature. Relative humidity is varied in a range of between 0.3 to 0.9 with 0.1 relative rises. Change between a step and a subsequent one was permitted only when the balance condition was reached (considering a weight change is lower than 0.003%).

The following Table 3 shows thermal and mechanical properties of a few obtained samples. Also a sample formulated according to Fp formulation, but post-cured 1 hour at 60° C., is enclosed. Referring to Table 3 samples, the following was noted. Fc sample is realized according to the commercial formulation and has high conversion rate, that is curing (98%). Fp sample is obtained from Fp formulation with a curing temperature of 60° C. Fp1 sample is obtained with Fp formulation with a curing temperature like environmental temperature and with diluent. Fps sample is obtained from Fp formulation with a silica filler amount of 5% by weight. Fp10 sample is obtained from Fp formulation with silica filler amount of 5% by weight and 10% by weight solvent.

TABLE 3

| components | | | | | |
|---|---|---|---|---|---|
| and | | | | | |
| properties | Fc | Fp | Fp1 | Fps | Fp10s |
| A: epoxy resin | x | x | x | x | x |
| B: filler | — | — | — | x | x |
| C: diluent | x | — | x | — | x |
| D: crosslinker | x | x | x | x | x |
| E: ind. | x | x | x | x | — |
| accelerator | | | | | |
| cur. temp. at | 1 week | 1 week | 1 week | 1 week | 1 week |
| environmental | | | | | |
| temperature | | | | | |
| α conversion | 98 | 90-92 | 88-91 | 88-91 | 88-91 |
| rate % | | | | | |
| T_{gu} (° C.) DSC | 50 | 87 | 85 | 99 | 102 |
| analysis | | | | | |
| T_{g} (DMA | 60 ± 3 | 81 ± 4 | 85 ± 3 | 76 ± 4 | 72 ± 3 |
| analysis) as | | | | | |
| maximum | | | | | |
| value of | | | | | |
| dissipation | | | | | |
| factor after | | | | | |
| curing cycle | | | | | |
| (° C.) | | | | | |
| E′ at 150° C. | 8 ± 5 | 23 | 23 | 19 ± 1 | 22 |
| (Mpa)** | | | | | |
| T_{g} after | 78 | 100 | | 99 | |
| climatic aging | | | | | |
| cycles* (DMA | | | | | |
| analysis) as | | | | | |
| maximum | | | | | |
| value of | | | | | |
| dissipation | | | | | |
| factor | | | | | |
| modulus | 2301 ± 99 | 2216 ± 44 | 2255 ± 368 | 2241 ± 155 | 2014 ± 70 |
| elasticity E | | | | | |
| (Mpa)*** | | | | | |
| maximum | 68 ± 2 | 84 ± 2 | 50 ± 8 | 47 ± 5 | 52 ± 8 |
| stress σₘₐₓ | | | | | |
| (MPa) | | | | | |
| breaking | 42 ± 3 | 71.8 ± 0.6 | 50 ± 8 | 47 ± 5 | 52 ± 8 |
| stress σ_{b} | | | | | |
| (MPa) | | | | | |
| breaking | 5.5 ± 0.7 | 6.3 ± 0.4 | 2.8 ± 0.4 | 3.5 ± 0.4 | 3.4 ± 0.4 |
| strain ε_{b} (%) | | | | | |

*after 210 aging cycles
**calculated from DMA analysis
***calculated as tensile test (ASTM D 638)

Referring to the three sample forms mentioned above (thin film, dog bone, reinforced polymer FRP), depending on the realized test shown in Table 3, a sample in the form established by standard regulating test execution conditions has been used. As to DMA analysis, for the different formulations samples have been employed having a rectangular thin film shape. The tensile analysis on the different polymer matrices has been carried out on samples with dog bone shape, whereas strain analysis was executed on samples not with dog bone shape having suitable size.

As shown from Table 3, modulus of elasticity values E are not very different for all the samples. As to the maximum stress σₘₐₓ (MPa), breaking stress σ_{b} (MPa) and breaking strain ε_{b} (%), the obtained values are much higher for sample Fp. Fp1, Fps and Fp10s samples have breaking stress values higher than those of commercial sample Fc.

Fire resistance property results are illustrated in example FIGS. 1, 2 and 3, in which commercial sample Fc shows a superior heat release rate (HHR) (FIG. 1) and it releases a higher CO (FIG. 2) and CO₂ (FIG. 3) content in comparison to Fp and Fps samples according to the examples of the invention.

In terms of water adsorption, both the curves of FIG. 4 indicate the adsorbed water according to the water activity. As shown in FIG. 4, the water adsorbed curve of commercial sample Fc (curve with spots) is higher than the observed for Fp10s samples (curve with squares).

For TMA analysis reference is made to the following Table 4.

TABLE 4

| | temperature range | α (° C.⁻¹)(*10⁻⁴) |
|---|---|---|
| Sample | (° C.) | coefficient |
| Fc commercial system | 55 ÷ 151 | 2.01 |
| Fc1 (further | 55 ÷ 150 | 1.95 |
| commercial system) | | |
| Fps | 55 ÷ 90 | 0.73 |
| | 90 ÷ 150 | 1.7 |
| Fp10s | 55 ÷ 90 | 0.79 |
| | 90 ÷ 150 | 1.73 |
| Fp | 55 ÷ 90 | 0.85 |
| | 90 ÷ 150 | 1.82 |

The fiber reinforced polymers FRP made in accordance with embodiments of the invention, in addition to the mechanical properties mentioned above, have also further significant characteristics for repairing e structural reinforcement applications, such as light weight, non-corrosive properties, quick and easy installation, low cost and satisfactory design. The FRP polymer frames can be made adhering to beams and plates or slabs for increasing their share and bending ability, and can be wrapped around columns for increasing their ability to carry load and ductility in case of earthquakes.

The fiber reinforced polymer FRP made in accordance with embodiments of the invention can be used, in addition to the construction sector, for many other industrial applications at environmental temperature, such as, for example, aerospace and motor industries and sporting plants.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A composition comprising:
an epoxy resin comprising at least a difunctional epoxy resin having a viscosity at environmental temperature in a range of between 1000 to 5000 mPa·s; and
at least one cross-linking agent for epoxy resin, said epoxy resin having a cross-linking temperature at a predetermined temperature.

2. The composition of claim 1, wherein the predetermined temperature is in a range of between one of 5° C. to 60° C., 10° C. to 50° C. and 15° C. to 35° C.

3. The composition of claim 1, further comprising a low viscosity diluent adapted to modulate the composition viscosity, wherein the low viscosity diluent is in an amount not higher than 10% by weight.

4. The composition of claim 3, wherein the diluent comprises one of a mono-ether and a diglycidil ether as a reactive solvent.

5. The composition of claim 1, wherein said epoxy resin has a cross-linking rate comprised in a range of between 80% to 96%.

6. The composition of claim 1, further comprising:
an accelerator for the at least one cross-linking agent; and
a filler.

7. The composition of claim 6, wherein the accelerator is at least one of aliphatic alcohol, aromatic alcohol, aliphatic polyalcohol, nonylphenol resin and hydrocarbon resin.

8. The composition of claim 6, wherein the filler is one selected from the group consisting of a filler based on silica nanoparticles dispersed in epoxy resins and a filler having silica nanoparticles directly produced in situ using a sol-gel method.

9. The composition of claim 6, wherein the filler comprises a silica nanoparticle dispersion in a diglycidil ether compound having no more than 2 epoxy groups per molecule.

10. The composition of claim 6, wherein the filler comprises silica nanoparticles directly produced in situ with a sol-gel method by mixing an organo-silica precursor dispersion in epoxy resin and in the at least one cross-linking agent.

11. The composition of claim 10, wherein the organo-silica precursor comprises organosilanes selected from the group consisting of tetraethoxysilane, glycidiloxypropyltrimethoxysilane and aminopropyltriethoxysilane.

12. The composition of claim 1, wherein the difunctional epoxy resin is selected from the group consisting of DGEBA and DGEBF.

13. The composition of claim 1, wherein the epoxy resin comprises at least a diglycidil ether compound having no more than 2 epoxy groups per molecule.

14. The composition of claim 1, wherein the at least one cross-linking agent is one selected from the group consisting of aromatic amine, aliphatic amine and meta-xylylendiamine.

15. The composition of claim 1, wherein said viscosity is in a range of between one of 3000 to 12000 mPa·s and 5000-9000 mPa·s.

16. The composition of claim 1, wherein the epoxy resin comprises at least one multifunctional epoxy resin selected from the group consisting of tetraglycidil-4,4′-diaminodiphenylmethane (TGDDM), triglycidil-p-aminophenol (TGAP) and epoxy-novolac resin.

17. A reinforced polymer comprising:
a polymer matrix including an epoxy resin comprising at least a difunctional epoxy resin having a viscosity at environmental temperature in a range of between 1000 to 5000 mPa·s, and at least one cross-linking agent for epoxy resin, said epoxy resin having a cross-linking temperature at a predetermined temperature; and
reinforcing fibers incorporated into said polymer matrix.

18. The reinforced polymer of claim 17, wherein said reinforcing fibers is selected from the group consisting of carbon fibers, glass fibers and kevlar fibers.

19. The reinforced polymer of claim 17, wherein said polymer matrix is applied onto said reinforcing fibers at environmental temperature.

20. A method of using a reinforced polymer material, said method comprising:
providing a reinforced polymer material by combining at environmental temperature reinforcing fibers with a polymer matrix that includes an epoxy resin comprising at least a difunctional epoxy resin having a viscosity at environmental temperature in a range of between 1000 to 5000 mPa·s, and at least one cross-linking agent for epoxy resin, said epoxy resin having a cross-linking temperature at a predetermined temperature; and then applying the reinforced polymer material to a structure which is exposed to a temperature greater than 40° C.
